(19) United States
(12) Patent Application Publication
(10) Pub. No.: US 2005/0204089 A1
(43) Pub. Date: Sep. 15, 2005

(54) METHOD AND RELATED SYSTEM FOR ACCESSING LPC MEMORY OR FIRMWARE MEMORY IN A COMPUTER SYSTEM

(76) Inventors: Chao-Ping Chuang, Tai-Chung City (TW); Jen-Chin Chan, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,016

(22) Filed: Jun. 13, 2004

(30) Foreign Application Priority Data
Mar. 11, 2004 (TW) 093106529

(51) Int. Cl. G06F 12/00; G06F 13/00

(52) U.S. Cl. 711/100; 710/305

(57) ABSTRACT

A method and related system for accessing low pin count (LPC) memory or firmware memory includes selecting an LPC memory or a firmware memory according to an input signal, recording an address of the selected memory, determining weather to read or write data according to the input signal, and accessing data accordingly.

### BACKGROUND OF INVENTION

1. Field of the Invention

The present invention relates to a method and the related system of accessing memory, more particularly to a method and the related system of accessing LPC memory or firmware memory.

2. Description of the Prior Art

In a conventional processor or a computer system, many circuits of different functions are integrated into a block to achieve a small layout area, lower power consumption and low cost.

Please refer to FIG. 1. FIG. 1 illustrates function blocks of a conventional computer system 10. The computer system 10 includes a central processing unit 12, a volatile memory 18 and a chipset 14 (such as north and south bridge chipset) connected to a memory device 20 and a peripheral controller 22A through a bus 16. The central processing unit 12 maintains operations of the computer system 10; the memory 18 registers data and programs for operations of the central processing unit 12; the memory device 20 can be a non-volatile memory device, such as flash memory, which supports the computer system 10. For example, the memory device 20 can be a basic input/output system (BIOS) of a flash memory to store programs for starting the computer system 10 (such as a variety of check processes and operation arguments). The peripheral controller 22A controls a peripheral device 22B (such as an input device, e.g. keyboard or mouse). The memory device 20 and the peripheral controller 22A connected to the chipset 14 and the bus 16 can exchange data with the central processing unit 12 to achieve the functionality of the computer system 10.

As shown in FIG. 1, the bus 16 is a significant data channel among the chipset 14, the memory device 20 and other devices. In modern computer systems, fewer wires are expected to be used to construct the bus 16. The fewer the wires of the bus 16, the fewer the pins of the chipset 14, the memory device 20, and the peripheral controller 22A. Therefore, areas and power dissipations of the chipset 14 and the memory device 20 are reduced efficiently. For example, the information company Intel has established a low pin count (LPC) bus standard, which is a bus protocol for exchanging data through an LPC bus. The LPC bus replaces the ISA bus and supports the interfaces of a keyboard, a mouse, a printer and other peripheral devices of slower transmission speed. The LPC standard operates at PCI 33MHz and uses fewer pins than the ISA standard. Therefore, the LPC standard has many advantages when applied to a desktop PC or a notebook.

In a conventional computer system, memory can be sorted into two kinds: LPC memory of the LPC standard and firmware memory, a kind of flash memory for storing BIOS information. There are two different control interfaces for accessing data in these two kinds of memories. The first control interface is used to connect a bus and the LPC memory and control the LPC memory accessing. The second control interface is used to connect a bus and the firmware memory and control the firmware memory accessing. In the prior art, controlling the LPC memory accessing is a procedure of determining addresses of the LPC memory and accessing data. Similarly, the accessing procedure of the firmware memory is like that of the LPC memory. The procedures of accessing data in the LPC memory and the firmware memory are described in detail in the following.

Please refer to FIG. 2. FIG. 2 illustrates a flowchart of reading data from a firmware memory. In step 100, a control interface resets all signals to clear previous instructions. In step 200, the control interface receives an input signal and determines whether the reading action is executed. In step 300, a firmware memory for data reading is selected by an input signal “identity selection” . If it is determined that the input signal informs the control interface to read data from a firmware memory, then execution of step 400 is maintained, in which a reading address of the firmware memory is received and latched from the input signal. In step 500, a buffer action that is to exchange or confirm the control right is performed. In step 600, data from the address of the firmware memory obtained in step 400 is read. Finally, a buffer action of exchanging the control right in step 700 is performed, finishing a cycle of reading data from the firmware memory.

Please refer to FIG. 3. FIG. 3 illustrates a flowchart of controlling the data writing of a firmware memory. In step 120, a reset is performed. In step 220, a control interface receives an input signal and determines if the data writing will be executed. In step 320, a firmware memory to in which write data is selected by an “identity selection” signal. In step 420, a writing address of the firmware memory is received and latched from the input signal. In step 520, data from the received input signal in the firmware memory is written. In the last step 620, a buffer action to perform the control right exchange and the control right confirmation is executed, finishing a cycle of data writing of the firmware memory.

Please refer to FIG. 4. FIG. 4 illustrates a flowchart of controlling a data reading of an LPC memory. Step 140 is to execute a reset. In step 240, an input signal is received and that the following actions are to access an LPC memory are confirmed. In step 340, which procedure will be performed between data writing and data reading for the LPC memory is determined. In FIG. 4, we only discuss the situation of data reading. In step 440, an address of the LPC memory for reading data is received and latched from the input signal. In step 540, a buffer action is performed. In step 640, data from the address obtained of the LPC memory in step 440 is read. Finally, a buffer action of exchanging the control right is performed in step 740, finishing a cycle of reading data from the LPC memory.

Please refer to FIG. 5. FIG. 5 illustrates a flowchart of controlling data writing of an LPC memory. The first three steps in FIG. 5 are similar to those in FIG. 4. In step 360, it is determined to execute writing action in an LPC memory. In step 460, an address of the LPC memory for writing data is received and latched from the input signal. In step 560, data from the received input signal is written into the LPC memory. In the last step 660, a buffer action to perform the control right exchange and the control right confirmation is executed, finishing a cycle of data writing of the LPC memory.

In the prior art, accessing of a firmware memory and an LPC memory can be performed respectively. However, accessing actions of two kinds of memories are controlled by different control interfaces. In the development of a modern computer system, chips of different standards are to be integrated together. Therefore, the interface for accessing of an LPC memory and the interface for accessing of a firmware memory should be integrated into a single chip to achieve the advantages of low cost, low power consumption and low layout area.

### SUMMARY OF INVENTION

It is therefore a primary objective of the claimed invention to provide a method of accessing data from an LPC memory and a firmware memory.

According to the claimed invention, a method of accessing data from an LPC memory and a firmware memory comprises: receive an input signal that comprises a memory flag; and accessing data from the LPC memory or the firmware memory according to the memory flag.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates function blocks of a conventional computer system.

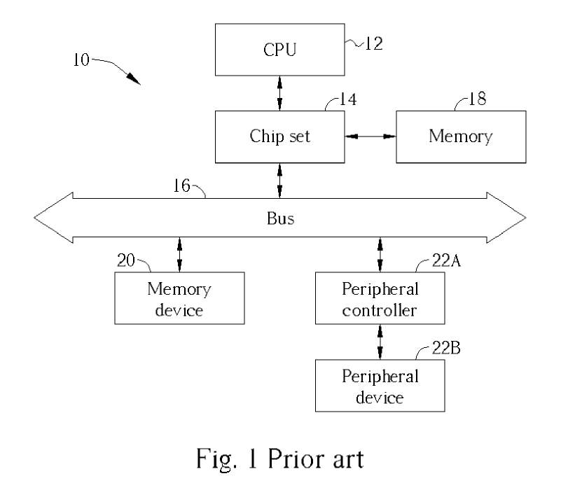

FIG. 2 illustrates a flowchart of reading data from a firmware memory according to the prior art.

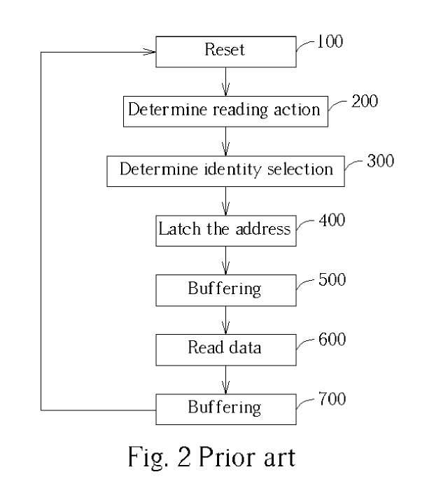

FIG. 3 illustrates a flowchart of controlling data writing of a firmware memory according to the prior art.

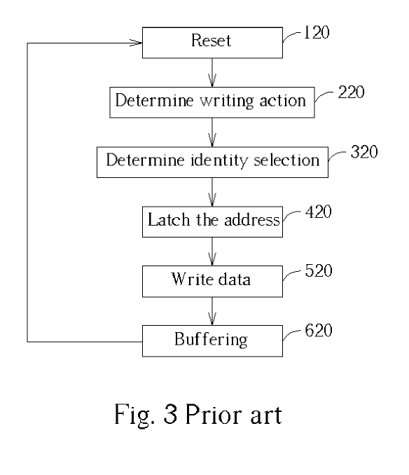

FIG. 4 illustrates a flowchart of controlling data reading of an LPC memory according to the prior art.

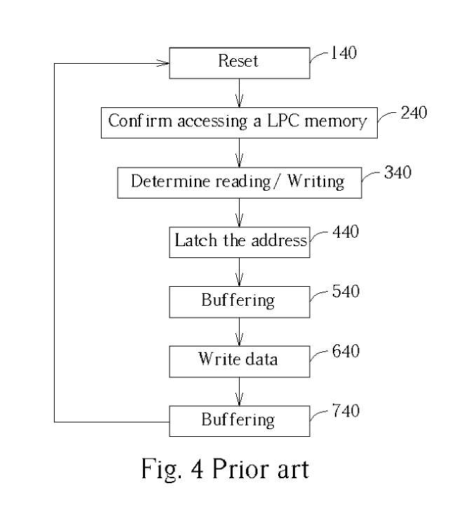

FIG. 5 illustrates a flowchart of controlling data writing of an LPC memory according to the prior art.

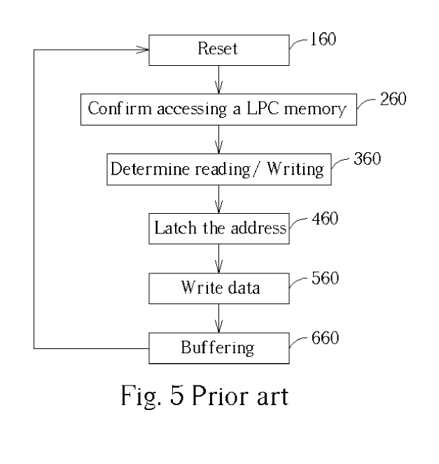

FIG. 6 illustrates the flowchart of accessing an LPC memory and a firmware memory according to the present invention.

FIG. 7 illustrates a computer system according to the present invention.

### DETAILED DESCRIPTION

For accessing data in an LPC memory, two state machines are needed to complete the procedure if implementing the accessing actions by way of a programming language. Similarly, for accessing data in a firmware memory, two state machines are also required. Intuitively, four state machines are included in the integration of data accessing for both an LPC memory and a firmware memory. However, the present invention implements accessing actions of both an LPC memory and a firmware memory by using only one state machine.

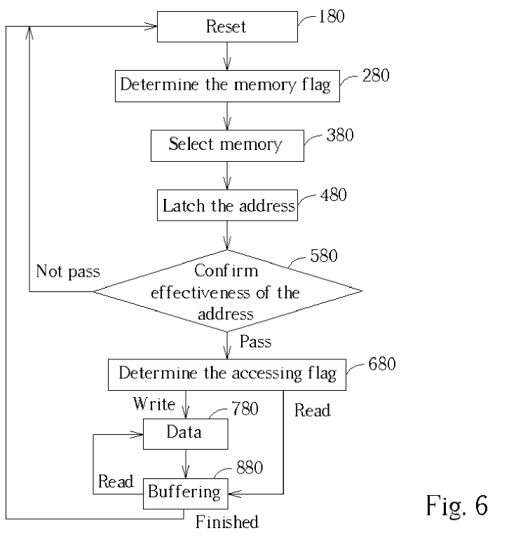

Please refer to FIG. 6. FIG. 6 illustrates a flowchart of accessing an LPC memory and a firmware memory according to the present invention. Before any other action is started, in step 180 all previous instructions are reset. In step 280, a signal “memory flag” is received. Because the present invention is able to access both an LPC memory and a firmware memory, the signal “memory flag” determines the type of the memory. In the preferred embodiment of the present invention, “memory flag” is a digital code comprising 0 or 1. One code represents the accessing for a LPC memory, and the other code represents the accessing for a firmware memory.

As long as the kind of memory is confirmed, one memory of the same kind is selected in step 380. In a computer system, the number of firmware memories is not limited to only one, so in step 380 one memory in a plurality of LPC memories or in a plurality of firmware memories has to be designated. In step 480, an address from the input signal is received and the address for the location of accessing data from the LPC memory or the firmware memory is latched. In step 580 an address confirmation is performed. Because the input signal consists of a plurality of 1s and 0s, if this digital signal is not checked, an incorrect signal can easily lead to errors. Step 580 confirms the input signal represents the memory address. As long as the confirmation is finished, either the subsequent step 680 is performed or step 180 is returned to.

In step 680, a signal “accessing flag” is received. The “accessing flag” is used to set reading data from or writing data to the memory. The “accessing flag” is a digital signal which has two kinds of contents in the preferred embodiment of the present invention. One content represents reading data and the other represents writing data. If it is decided to write data into the memory, step 780 is performed, wherein the data in the input signal is written into the memory corresponding to the address obtained from step 480. In step 880, a buffering action is executed. The buffering action includes exchange of the control right, confirmation of the reading/writing action, and time buffering. Because the present invention is realized in one state machine, confirmation of the reading/writing action should be repeated in all the procedures. The time buffering is to balance the timing between the procedures of reading and writing. As shown in FIG. 6, if in step 680, it is decided that reading action is performed first, the buffering action is executed first in step 880, and then step 780 is executed wherein data from the LPC memory or the firmware memory is read according to the address obtained in step 480. After finishing data reading, buffering action in step 880 is executed. The cycle is ended in step 880, and the next new cycle is started from step 180. The sequence of the steps in the present method shown in FIG. 6 is the preferred embodiment. However, the sequence of the steps can be changed to achieve the purpose of the present invention.

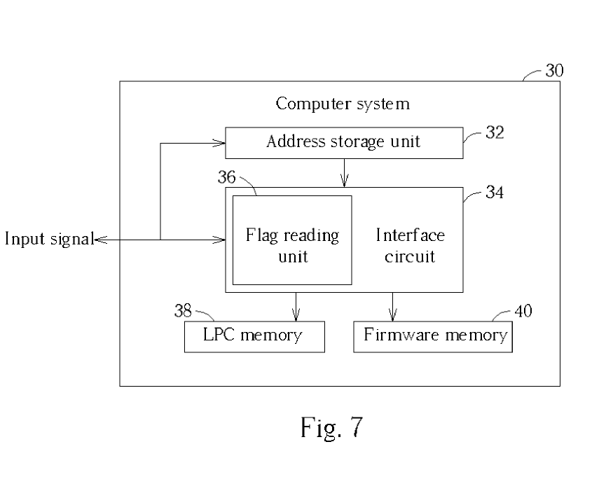

Please refer to FIG. 7. FIG. 7 illustrates a computer system 30 according to the present invention. The computer system 30 is used to access data of an LPC memory and a firmware memory. The computer system 30 comprises an address storage unit 32, an interface circuit 34, an LPC memory 38, and a firmware memory 40. The interface circuit 34 further comprises a flag reading unit 36. The function of the interface circuit 34 is to connect the address storage unit 32, the LPC memory 38 and the firmware memory 40. The interface circuit 34 also determines a next action to be executed according to an input signal. At first, the interface circuit 34 receives a trigger signal from an input signal and resets all instructions recorded in the interface circuit 34. Then, the flag reading unit 36 in the interface circuit 34 reads a signal “memory flag ” from the input signal. The signal “memory flag” designates the LPC memory 38 or the firmware memory 40 for accessing data. The interface circuit 34 contacts the LPC memory 38 or the firmware memory 40 according to the signal of “memory flag”.

The address storage unit 32 receives and latches an address from the input signal. The address represents the location of the accessing data in the LPC memory 38 or the firmware memory 40. The interface circuit 34 performs a confirmation procedure for the address stored in the address storage unit 32. Then, the flag reading unit 36 reads a signal “accessing flag”, which determines reading or writing action for the designated memory. Finally, the interface circuit reads data or writes data in the LPC memory 38 or the firmware memory 40 according to the address latched in the address storage unit 32 and the signal in the flag reading unit 36.

In the prior art, two separate and unrelated chips are needed to perform data accessing for an LPC memory and a firmware memory. In the present invention, one computer system in one chip is able to implement the data accessing for both an LPC memory and a firmware memory. Moreover, the data accessing method of the present invention utilizes the concept of a single state machine to complete all procedures. Therefore, the present invention has the advantages of low power consumption, low cost, low layout area and low hardware complexity due to all integrate circuits being on one chip.

Those skilled in the art will readily observe that numerous modifications and alterations of the device may be made while retaining the teachings of the invention. Accordingly, the above disclosure should be construed as limited only by the metes and bounds of the appended claims.

1. A method of accessing data from a low pin count (LPC) memory and a firmware memory comprising:
receiving an input signal comprising a memory flag; and
accessing data from the LPC memory or the firmware memory according to the memory flag.

2. The method of accessing data from an LPC memory and a firmware memory in claim 1 wherein the input signal further comprises an accessing address and an accessing flag.

3. The method of accessing data from an LPC memory and a firmware memory in claim 2 wherein accessing data from the LPC memory or the firmware memory is according to the accessing address.

4. The method of accessing data from an LPC memory and a firmware memory in claim 2 wherein accessing data from the LPC memory or the firmware memory is according to the accessing flag.

5. The method of accessing data from an LPC memory and a firmware memory in claim 1 further comprising resetting all previous instructions.

6. A computer system comprising:
an interface circuit for receiving an input signal comprising a memory flag, the interface circuit comprising a flag reading unit for reading the memory flag of the input signal, the interface circuit for accessing data from an LPC memory or a firmware memory according to the memory flag; and
an address storage unit for storing an accessing address of the LPC memory or the firmware memory.

7. The computer system in claim 6 wherein the input signal further comprises the accessing address and an accessing flag, which defines whether data is to be read from or written into the LPC memory or the firmware memory.

8. The computer system in claim 6 further comprising an LPC memory and a firmware memory.
